(19) United States
(12) Patent Application Publication
(10) Pub. No.: US 2015/0206251 A1
(43) Pub. Date: Jul. 23, 2015

(54) Method and system for Virtual Account Number-Based Travel Expense Controls and Accounting

(71) Applicant: MasterCard International Incorporated, Purchase, NY (US)

(72) Inventors: Jose Luis YOFE, Danbury, CT (US); Richard Francis Crum, Stamford, CT (US)

(73) Assignee: MasterCard International Incorporated, Purchase, NY (US)

(21) Appl. No.: 14/158,833

(22) Filed: Jan. 19, 2014

(51) Int. Cl. G06Q 40/00; G06Q 20/40

(52) U.S. Cl. CPC G06Q 40/12; G06Q 20/40

(57) ABSTRACT

A method for providing enhanced control of travel purchases includes: storing rule data entries, each entry including data related to an employer rule including a rule identifier and at least one data requirement; receiving a payment number request including a specific rule identifier, payment amount, and data fields; identifying a specific rule data entry where the rule identifier corresponds to the specific rule identifier; identifying a controlled payment number configured for use for a single payment transaction if data included in the data fields satisfies the at least one data requirement included in the specific rule data entry; transmitting the identified controlled payment number; storing a transaction record including the identified controlled payment number and data fields; receiving purchase data corresponding to a purchase made using the identified controlled payment number, the purchase data including the controlled payment number; and associating the stored transaction record with the received purchase data.

### FIELD

The present disclosure relates to the providing of enhanced control of travel purchases, specifically the use of controlled payment numbers to provide for more secure travel purchases and enhanced accounting and data reconciliation.

### BACKGROUND

Travel management companies (TMCs) assist both individual consumers and various entities, such as corporations, in making travel arrangements. These travel management companies may assist consumers (e.g., and entities) by making reservations for air travel, hotel stays, rental cars, and other travel-related services via global distribution systems that enable automated transactions between the TMC and vendors that offer the travel services. Travel management companies can ease the burden on consumers and entities by arranging their travel services on their behalf, thereby relieving stress and the workload on the consumer.

Although travel management companies may assist consumers and entities by conducting transactions on their behalf, conducting traditional payment transactions creates a potential for fraud to occur that could be of a detriment to the client, the TMCs, and/or the vendor. In addition, some TMCs may regularly conduct a staggering of transactions for its clients, which may sometimes be a single, large corporate client. With such a large volume of transactions, the losses caused by fraud may be significant. Furthermore, it may be exceedingly difficult for the TMC and/or the client to adequately keep track of each transaction with regard to the related travel.

Thus, there is a need for a technical solution to provide for more secure transaction processing for transactions related to travel services that may also increase the ability to reconcile data related to each individual transaction.

### SUMMARY

The present disclosure provides a description of systems and methods for providing enhanced control of travel purchases.

A method for providing enhanced control of travel purchases includes: storing, in a rules database, a plurality of rule data entries, wherein each rule data entry includes data related to an employer purchasing rule including at least a rule identifier and at least one data requirement; receiving, by a receiving device, a payment number request, wherein the payment number request includes at least a specific rule identifier, a payment amount, and a plurality of data fields; identifying, in the rules database, a specific rule data entry where the included rule identifier corresponds to the specific rule identifier; identifying, by a processing device, a controlled payment number configured for use for a single payment transaction if data included in the plurality of data fields satisfies the at least one data requirement included in the specific rule data entry; transmitting, by a transmitting device, the identified controlled payment number; storing, in a records database, a transaction record including at least the identified controlled payment number and the plurality of data fields; receiving, by the receiving device, purchase data corresponding to a purchase made using the identified controlled payment number, wherein the purchase data includes at least the controlled payment number; and associating, in the records database, the stored transaction record with the received purchase data.

A system for providing enhanced control of travel purchases includes a records database, a rules database, a receiving device, a processing device, and a transmitting device. The rules database is configured to store a plurality of rule data entries, wherein each rule data entry includes data related to an employer purchasing rule including at least a rule identifier and at least one data requirement. The receiving device is configured to receive a payment number request, wherein the payment number request includes at least a specific rule identifier, a payment amount, and a plurality of data fields. The processing device is configured to: identify, in the rules database, a specific rule data entry where the included rule identifier corresponds to the specific rule identifier; and identify a controlled payment number configured for use for a single payment transaction if data included in the plurality of data fields satisfies the at least one data requirement included in the specific rule data entry. The transmitting device is configured to transmit the identified controlled payment number. The processing device is further configured to store, in the records database, a transaction record including at least the identified controlled payment number and the plurality of data fields. The receiving device is further configured to receive purchase data corresponding to a purchase made using the identified controlled payment number, wherein the purchase data includes at least the controlled payment number. The processing device is further configured to associate, in the records database, the stored transaction record with the received purchase data.

### BRIEF DESCRIPTION OF THE DRAWING FIGURES

The scope of the present disclosure is best understood from the following detailed description of exemplary embodiments when read in conjunction with the accompanying drawings. Included in the drawings are the following figures:

FIG. 1 is a high level architecture illustrating a system for providing enhanced control of travel purchases.

FIG. 2 is a block diagram illustrating the processing server of FIG. 1 for the enhanced control of travel purchases in accordance with exemplary embodiments.

FIG. 3 is a flow diagram illustrating a method for distributing a controlled payment number for use in a controlled travel purchase in accordance with exemplary embodiments.

FIG. 4 is a flow diagram illustrating a method for reconciling a controlled travel purchase with purchase data for distributing to a client in accordance with exemplary embodiments.

FIGS. 5A-5C illustrate a graphical user interface for the requesting and receiving of a controlled payment number for use in a controlled travel purchase in accordance with exemplary embodiments.

FIG. 6 is a flow chart illustrating an exemplary method for providing enhanced control of travel purchases in accordance with exemplary embodiments.

FIG. 7 is a block diagram illustrating a computer system architecture in accordance with exemplary embodiments.

Further areas of applicability of the present disclosure will become apparent from the detailed description provided hereinafter. It should be understood that the detailed description of exemplary embodiments are intended for illustration purposes only and are, therefore, not intended to necessarily limit the scope of the disclosure.

### DETAILED DESCRIPTION

### Definition of Terms

Payment Network—A system or network used for the transfer of money via the use of cash-substitutes. Payment networks may use a variety of different protocols and procedures in order to process the transfer of money for various types of transactions. Transactions that may be performed via a payment network may include product or service purchases, credit purchases, debit transactions, fund transfers, account withdrawals, etc. Payment networks may be configured to perform transactions via cash-substitutes, which may include payment cards, letters of credit, checks, financial accounts, etc. Examples of networks or systems configured to perform as payment networks include those operated by MasterCard®, VISA®, Discover®, American Express®, etc.

Payment Account—A financial account that may be used to fund a transaction, such as a checking account, savings account, credit account, secured or unsecured loan or mortgage account, debit account, pre-paid account, virtual payment account, vendor account (e.g., a utility), etc. and mixtures thereof. A payment account may be associated with an entity, which may include a person, family, company, corporation, governmental entity, etc. In some instances, a payment account may be virtual, such as those accounts operated by PayPal®, etc.

Payment Card—A card or data associated with a payment account that may be provided to a merchant in order to fund a financial transaction via the associated payment account. Payment cards may include credit cards, debit cards, charge cards, stored-value cards, prepaid cards, fleet cards, virtual payment numbers, virtual card numbers, controlled payment numbers, etc. A payment card may be a physical card that may be provided to a merchant, or may be data representing the associated payment account (e.g., as stored in a communication device, such as a smart phone or computer). For example, in some instances, data including a payment account number may be considered a payment card for the processing of a transaction funded by the associated payment account. In some instances, a check may be considered a payment card where applicable.

Controlled Payment Number—Controlled payment numbers may be payment numbers associated with a payment account that are subject to one or more rules. In many cases, these rules may be set by a cardholder, such as spending limits, limits on days and/or times of a transaction, limits on merchants or industries, transaction spending or frequency limits, etc. Controlled payment numbers may offer an account holder an opportunity to give payment cards tied to the account to others for use, but subject to rules set by the cardholder, such as an employer distributing cards to employees, or a parent distributing cards to children. Additional detail regarding controlled payment numbers may be found in U.S. Pat. No. 6,636,833, issued Oct. 21, 2003; U.S. Pat. No. 7,136,835, issued Nov. 14, 2006; U.S. Pat. No. 7,571,142, issued Aug. 4, 2009; U.S. Pat. No. 7,567,934, issued Jul. 28, 2009; U.S. Pat. No. 7,593,896, issued Sep. 22, 2009; U.S. patent application Ser. No. 12/219,952, filed Jul. 30, 2008; U.S. patent application Ser. No. 12/268,063, filed Nov. 10, 2008; and U.S. patent application Ser. No. 12/359,971, filed Jan. 26, 2009; each of which are herein incorporated by reference in their entirety.

### System for Providing Enhanced Control of Travel Purchases

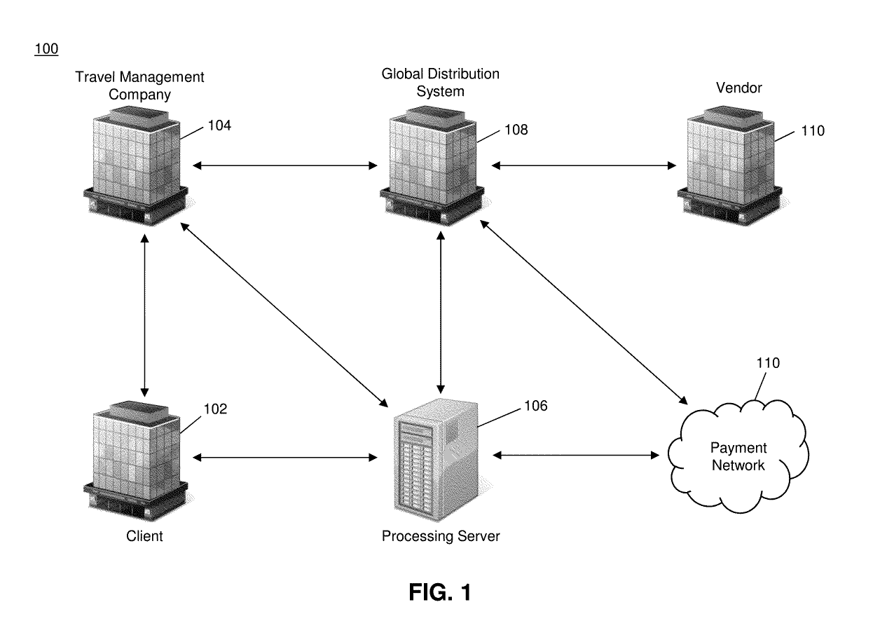

FIG. 1 illustrates a system 100 for providing enhanced control of travel purchases via the use of controlled payment numbers and data reconciliation.

A client 102, such as a consumer, an entity (e.g., a corporation, business, partnership, etc.), etc., may have a desire to make travel arrangements. The client 102 may contact a travel management company 104 in order to make their arrangements. The client 102 may provide the travel management company 104 with details regarding their desired arrangement, such as, in the case of air travel, desired departure and arrival dates, departure and arrival airports, and any relevant preferences (e.g., aisle or window seats, airline preferences, etc.). The client 102 may also provide the travel management company 104 with payment details to be used to fund the purchase of the desired travel services.

The client 102 may also have business rules regarding travel purchases. For example, a corporation may establish business rules regarding the maximum amount of a travel purchase, eligible vendors, locations that may be visited, services that may be used, information that must be included when making a purchase (e.g., an invoice or purchase order number, an employee number, a task or action code, etc.), etc. The client 102 may provide the business rule or rules to a processing server 106. The processing server 106, discussed in more detail below, may store the business rules in a rules database, also discussed in more detail below.

Once the travel management company 104 has received the information from the client 102, the travel management company 104 may provide information regarding the desired travel services to the processing server 106, including at least the payment details. The processing server 106 may review the information and check it against the business rules provided by the client 102. If the check indicates that the information provided to the travel management company 104 is in violation of one or more business rules (e.g., an ineligible vendor is selected, an invalid task code was used, etc.), then the processing server 106 may notify the travel management company 104 and request corrected information. In some embodiments, the processing server 106 may also transmit a notification to the client 102 regarding the violation of the business rules.

If the check indicates that the information provided by the client 102 is pursuant to the business rules, then the processing server 106 may identify a controlled payment number (CPN) to be issued for the subsequent payment transaction. The controlled payment number may be a single-use or limited-use number that may be valid only for the subsequent payment transaction via controls or limits placed on the controlled payment number. The controls or limits may include, for example, the controlled payment number being limited to the desired vendor, a transaction amount identified by the travel management company, a specific time and/or date (e.g., the date on which the travel management company 104 requests the CPN), etc. The processing server 106 may map the identified controlled payment number to a payment account indicated in the received payment details.

The processing server 106 may transmit the identified controlled payment number to the travel management company 104. The travel management company 104 may then purchase and/or reserve the desired travel services via a global distribution system 108, or other travel booking or reservation system, using the controlled payment number. The global distribution system 108 may be any suitable system used to enable transactions between vendors and clients, such as Amadeus, Sabre, Apollo, Galileo, Worldspan, Pegasus, Activity Link Systems, and other suitable systems as will be apparent to persons having skill in the relevant art. The global distribution system 108 may contact a vendor 112 with whom the services are to be purchased to arrange for the purchase and/or reservation. The global distribution system 108 may also submit an authorization request to the payment network 110 for a payment transaction between the travel management company 104 (e.g., on behalf of the client 102) and the vendor 112.

The payment network 110 may identify the controlled payment number used to fund the transaction as a CPN and may transmit a request for an account number to the processing server 106, wherein the request includes at least the controlled payment number and transaction details. The processing server 106 may review the transaction details to determine if the transaction satisfies the limits or controls placed on the controlled payment number. If the transaction is invalid based on the limits placed on the CPN, the processing server 106 may notify the payment network 110 to deny the transaction. If the transaction is valid, the processing server 106 may identify the associated payment account number based on the controlled payment number, and transmit the payment account number as a response to the payment network 110. The payment network 110 may then process the payment transaction using the payment account number using systems and methods that will be apparent to persons having skill in the relevant art.

Once the transaction has been processed, the global distribution system 108 may notify the travel management company 104 of the successful transaction, which in turn may notify the client 102. As part of the processing of the travel purchase, the global distribution system 108 or other third party (e.g., a travel reservation system) may store purchase data regarding the travel purchase (e.g., itinerary details, passenger or guest details, etc.) as will be apparent to persons having skill in the relevant art. The purchase data may include at least the controlled payment number associated with the reservation and/or purchase.

The processing server 106 may obtain (e.g., request, receive, etc.) the purchase data for the purchase and/or reservation, the purchase data including the controlled payment number. The processing server 106 may then identify a transaction record for the payment transaction including the controlled payment number, and associate the transaction record with the purchase data. This may result in reconciled purchase and transaction data using a single controlled payment number, which may provide for reconciled data with increased efficiency and a higher chance of success. The processing server 106 may then make the reconciled data available to the travel management company 104 and/or the client 102. This may, in turn, increase the record-keeping capabilities and improve business efficiency and performance of both the travel management company 104 and client 102 without modification to existing systems.

### Processing Device

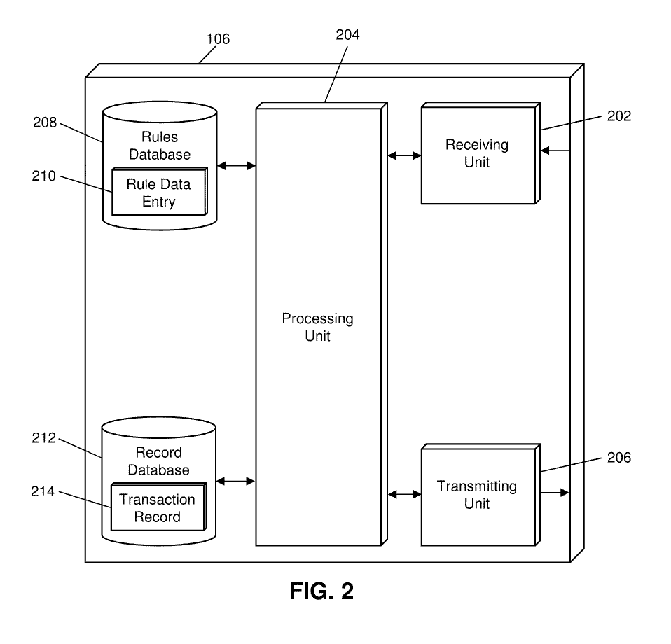

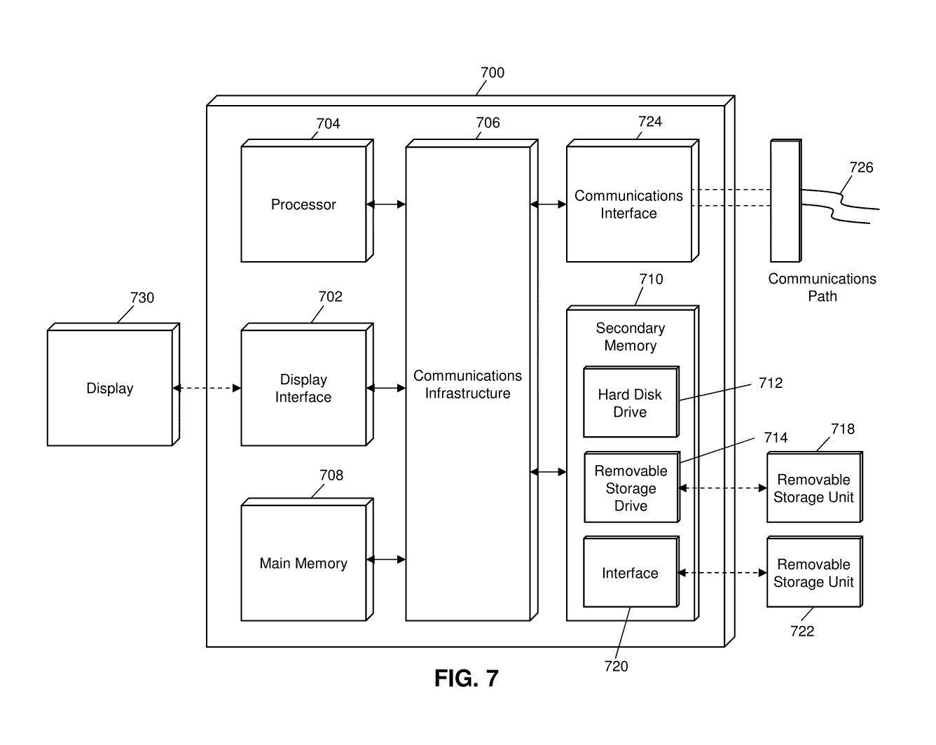

FIG. 2 illustrates an embodiment of the processing server 106 of the system 100. It will be apparent to persons having skill in the relevant art that the embodiment of the processing server 106 illustrated in FIG. 2 is provided as illustration only and may not be exhaustive to all possible configurations of the processing server 106 suitable for performing the functions as discussed herein. For example, the computer system 700 illustrated in FIG. 7 and discussed in more detail below may be a suitable configuration of the processing server 106.

The processing server 106 may include a receiving unit 202. The receiving unit 202 may be configured to receive data over one or more networks via one or more network protocols. The receiving unit 202 may be configured to receive business rule data from the client 102. The processing server 106 may also include a processing unit 204. The processing unit 204 may be configured to store the received business rule data as one or more rule data entries 210 in a rules database 208.

Each rule data entry 210 may include data related to an employer purchasing rule (e.g., the business rule) including at least a rule identifier and at least one data requirement. The rule identifier may be a value used for identification of the rule data entry 210, such as an identification number. In some instances, the rule identifier may be associated with the client 102 to whom the rule is associated with, such as an employer identification number, a payment account number of a payment account associated with the client 102, etc. In other instances, the rule identifier may be a unique identifier. In such an instance, each rule data entry 210 may further include an identifier associated with the client 102 for identification of the rule during processing.

The data requirement may indicate a data field that may be included in a request for a controlled payment number and one or more requirements for the corresponding data field. For example, a data requirement may require that employee identification numbers are to be submitted in each payment number request and that each employee identification number must be formatted with the letter “E” followed by a five digit number. Suitable types of data requirements that may be used in the systems and methods discussed herein will be apparent to persons having skill in the relevant art.

The receiving unit 202 may be further configured to receive a payment number request from the travel management company 104. The payment number request may include a plurality of data fields (e.g., related to the requested travel purchase), a payment or transaction amount, a specific rule identifier, and payment details. The processing unit 204 may identify one or more corresponding rule data entries 210 in the rules database 208 based on the specific rule identifier. The processing unit 204 may then identify if the data fields in the payment number request satisfy the data requirements included in each of the identified one or more rule data entries 210.

If the data requirements are not satisfied, the processing unit 204 may determine that the request is to be denied. The processing server 106 may include a transmitting unit 206, which may be configured to transmit data over one or more networks via one or more network protocols, such as the transmission of a message or notification to the travel management company 104 to indicate that the data requirements are not satisfied in the payment request. In some embodiments, the transmitting unit 206 may be further configured to transmit a notification to the client 102 indicating the invalid request.

If the data requirements are satisfied by the payment request, the processing unit 204 may identify a controlled payment number. The processing unit 204 may also establish limits on the controlled payment number corresponding to the transaction or payment amount and/or the information included in the plurality of data fields included in the payment request. Systems and methods for identifying a controlled payment number and establishing limits thereon will be apparent to persons having skill in the relevant art. The transmitting unit 206 may be configured to transmit the identified controlled payment number to the travel management company 104.

In some instances, an image of a payment card may be required (e.g., by a vendor 112) for a travel purchase. In such an instance, the payment request may include a request for a card image for a payment card to be associated with the controlled payment number. The processing unit 204 may be configured to generate a card image including the controlled payment number. In one embodiment, the processing unit 204 may further generate at least an expiration date and security code (e.g., card validation code) to be included in the generated card image. The transmitting unit 206 may be configured to transmit the generated card image to the travel management company 104 in lieu of, or in addition to, the controlled payment number. In some embodiments, the processing unit 204 may generate an image of both the front and back of a payment card. Generated images of the payment card may also include additional information, such as an issuer logo, as will be apparent to persons having skill in the relevant art.

In some embodiments, the processing unit 204 may store the controlled payment number and the associated payment account number included in the payment details included in the payment request. The processing unit 204 may also store the limits or controls associated with the controlled payment number. In some instances, the receiving unit 202 may receive a request from the payment network 110 for a payment account number, the request including a controlled payment number and transaction details. In such an instance, the processing unit 204 may identify a payment account number corresponding to the controlled payment number, and may provide the payment account number to the payment network 110 if the transaction details satisfy the limits or controls placed on the controlled payment number. In other instances, the transmitting unit 206 may transmit controlled payment number, payment account number, and limits and controls to the payment network 110 for use processing. In some embodiments, the processing server 106 may be part of the payment network 110.

The processing unit 204 may be further configured to store a transaction record 214 in a record database 212, wherein the transaction record 214 includes data related to the payment transaction funded via the controlled payment number. The transaction record 214 may include data fields included in the payment number request, and may also include transaction data received from the payment network 110 for the payment transaction. The transaction data may be received during processing of the controlled payment number, after the processing of the transaction by the payment network 110, upon request of the processing server 106, etc. In one embodiment, the transaction data may be included in a copy of the authorization request for the payment transaction.

The receiving unit 202 may be configured to receive purchase data corresponding to a travel purchase made using the controlled payment number. In some instances, the purchase data may be received by the receiving unit 202 in response to the transmitting of a request for the purchase data via the transmitting unit 206. The purchase data may include at least the controlled payment number and additional data. The processing unit 204 may identify a transaction record 214 associated with the controlled payment number and associate the purchase data with the transaction record 214.

In some embodiments, the receiving unit 202 may receive a request for transaction and/or purchase data associated with a controlled payment number. The processing unit 204 may be configured to identify the requested data in a transaction record 214 in the record database 212 based on the provided controlled payment number. The transmitting unit 206 may be configured to transmit the requested data in response to the received request.

### Method for Identifying and Distributing a Controlled Payment Number

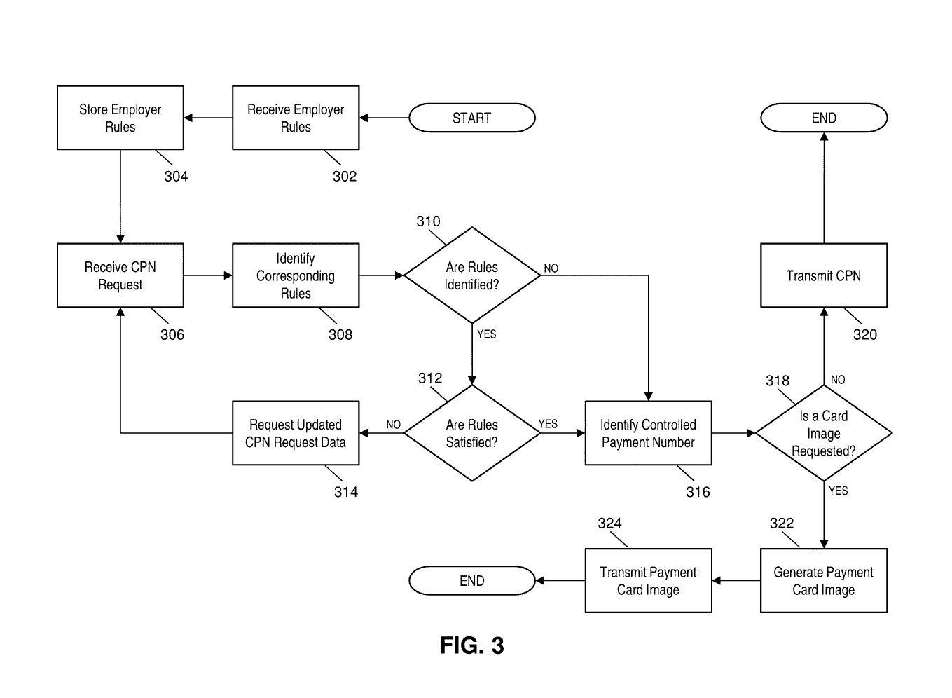

FIG. 3 illustrates a method for the identifying and distributing of a controlled payment number in response to a payment number request.

In step 302, the receiving unit 202 of the processing server 106 may receive employer purchasing rules from the client 102. The employer purchasing rules may include at least one data requirement, which may identify a data field and a requirement for a value of the corresponding data field. In step 304, the processing unit 204 of the processing server 106 may store the received employer purchasing rules as rule data entries 210 in the rules database 208.

In step 306, the receiving unit 202 may receive a request for a controlled payment number from the travel management company 104, the request including at least a specific rule identifier, a payment amount, a plurality of data fields, and a payment account number. In step 308, the processing unit 204 may identify corresponding rule data entries 210 in the rules database 208 based on the specific rule identifier. In step 310, the processing unit 204 may determine if any rules were identified in step 308 that should be applied to the payment number request. If rules were identified, then, in step 312, the processing unit 204 may determine if the data fields included in the payment number request satisfy the data requirements of each of the identified rules.

If the data requirements of each of the identified rules are not satisfied, then, in step 314, the transmitting unit 206 may transmit a notification to the travel management company 104 requesting updated data fields. The process may then return to step 306 where the receiving unit 202 may await an updated controlled payment number request. Once the processing unit 204 determines that the data requirements of each of the identified rules are satisfied, or if no data requirements need to be met, then, in step 316, the processing unit 204 may identify a controlled payment number. In some embodiments, identification of the controlled payment number may include storing of an association of the identified controlled payment number with the payment account number included in the payment number request and limits and/or controls on the controlled payment number based on the included data fields.

In step 318, the processing unit 204 may determine if a card image is requested by the travel management company 104. The payment number request may include an indication of a request for a card image to be generated for providing to the vendor 112. In some instances, the payment number request may indicate the vendor 112, and the processing unit 204 may identify if the vendor 112 requires an image of the payment card. If a card image is not requested, then, in step 320, the transmitting unit 206 may transmit the controlled payment number to the travel management company 104 for use in conducting the payment transaction.

If a card image is requested, then, in step 322, the processing unit 204 may generate an image of a payment card including at least the controlled payment number. In some embodiments, the processing unit 204 may generate additional features of the payment card image, such as an expiration date or security code. In some instances, the payment number request may indicate card features to be included in the payment card image. In step 324, the transmitting unit 206 may transmit the generated card image to the travel management company 104.

### Reconciliation of Transaction and Purchase Data

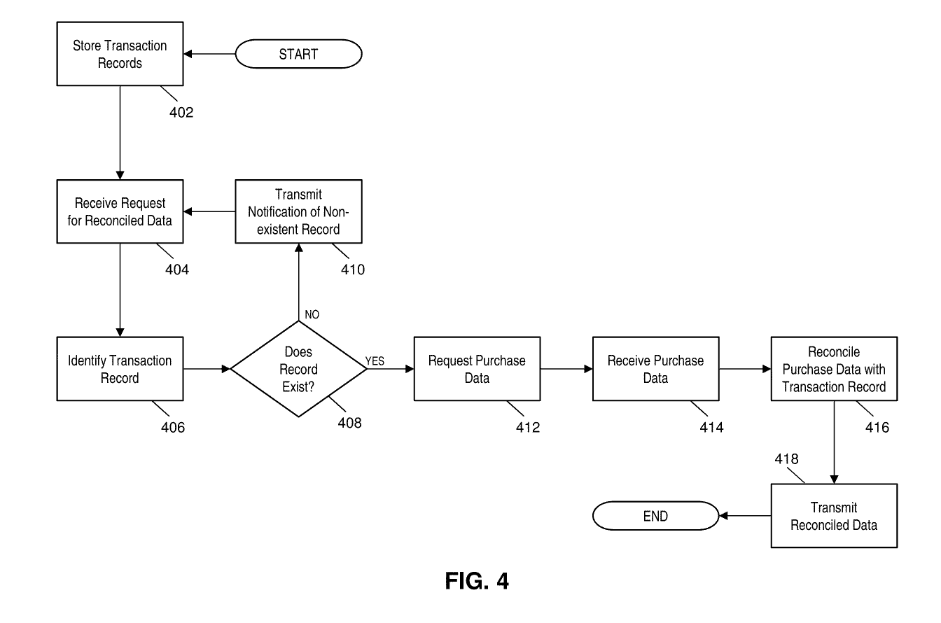

FIG. 4 illustrates a process for the reconciliation of transaction data and purchase data for a travel purchase facilitated via a controlled payment number using systems and methods discussed herein.

In step 402, the processing unit 204 may store a plurality of transaction records 214 in the record database 212. Each transaction record 214 may include transaction data related to a payment transaction including at least a controlled payment number used to fund the related payment transaction. Additional transaction data may include a transaction amount, transaction time and/or date, merchant data, consumer data, product data, or other information that will be apparent to persons having skill in the relevant art.

In step 404, the receiving unit 202 of the processing server 106 may receive a request for reconciled data (e.g., from the travel management company 104 and/or the client 102). The request for reconciled data may include at least the controlled payment number used to purchase travel services for which the reconciled data is requested. In step 406, the processing unit 204 may identify a transaction record 214 in the record database 212 where the included controlled payment number corresponds to the controlled payment number received in the request.

In step 408, the processing server 106 may determine if a transaction record 214 corresponding to the controlled payment number was successfully identified. If no transaction record 214 was found corresponding to the controlled payment number, then, in step 410, the transmitting unit 206 of the processing server 106 may transmit a notification of the non-existent transaction record 214 to the entity that requested the reconciled data. Then, the process may return to step 404, where the receiving unit 202 may await a new and/or updated request.

If a transaction record 214 corresponding to the controlled payment number is identified, then, in step 412, the processing server 106 may request (e.g., via the transmitting unit 206) purchase data from a third party, such as the global distribution system 108 or other booking or reservation system. The request may include at least the controlled payment number for identification of the purchase data. In step 414, the receiving unit 202 may receive purchase data for the purchased travel services from the third party.

In step 416, the processing unit 204 may reconcile the received purchase data with the identified transaction record 214. In some embodiments, reconciling the data may include associating the transaction record 214 with the received purchased data. In some instances, the processing unit 204 may store the purchase data in the transaction record 214. In another instance, the processing unit 204 may store the purchase data as a purchase record in a purchase database, the purchase record including the controlled payment number for identification. In this regard, U.S. Pub. Pat. Appl. No. 2013/0232035 and U.S. Pat. No. 8,527,416 are incorporated herein by reference. In step 418, the transmitting unit 206 may transmit the reconciled data in response to the original request. In some instances, the transmitting unit 206 may transmit only such purchase and/or transaction data as indicated in the original request.

### Graphical User Interface

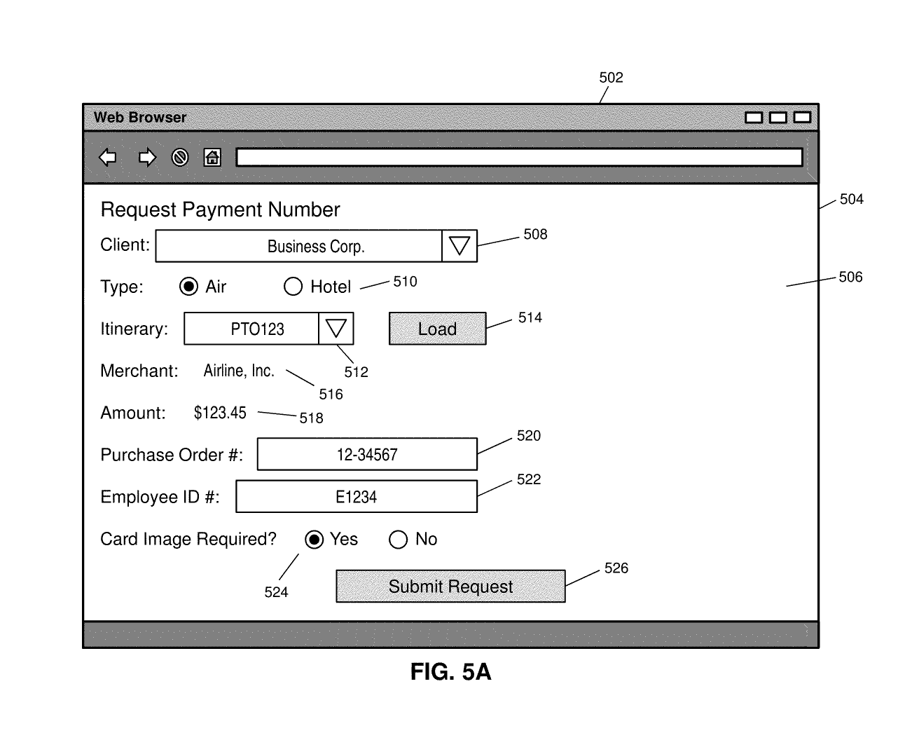

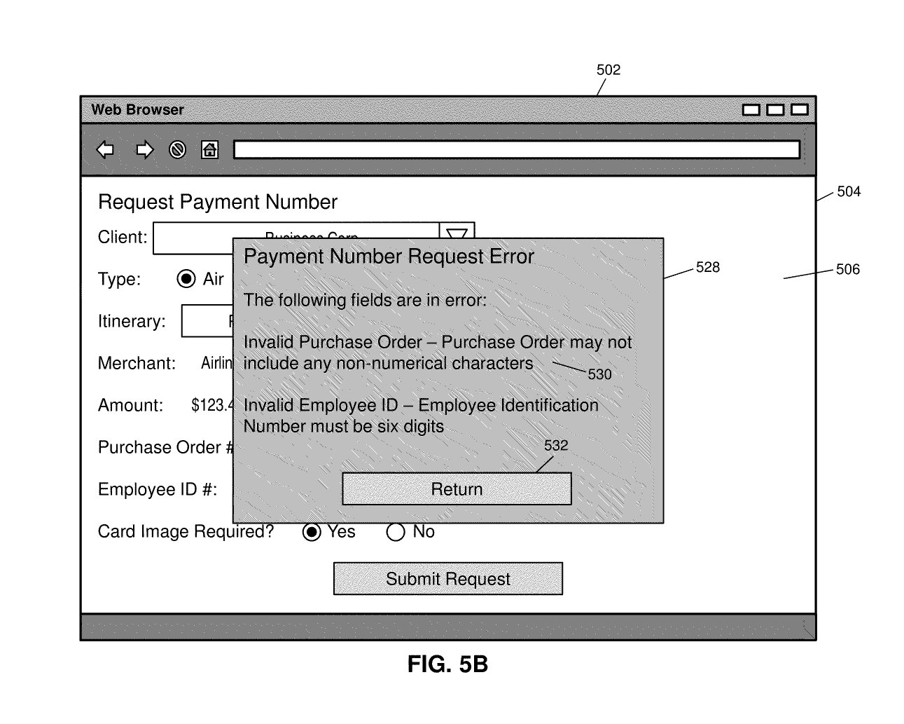

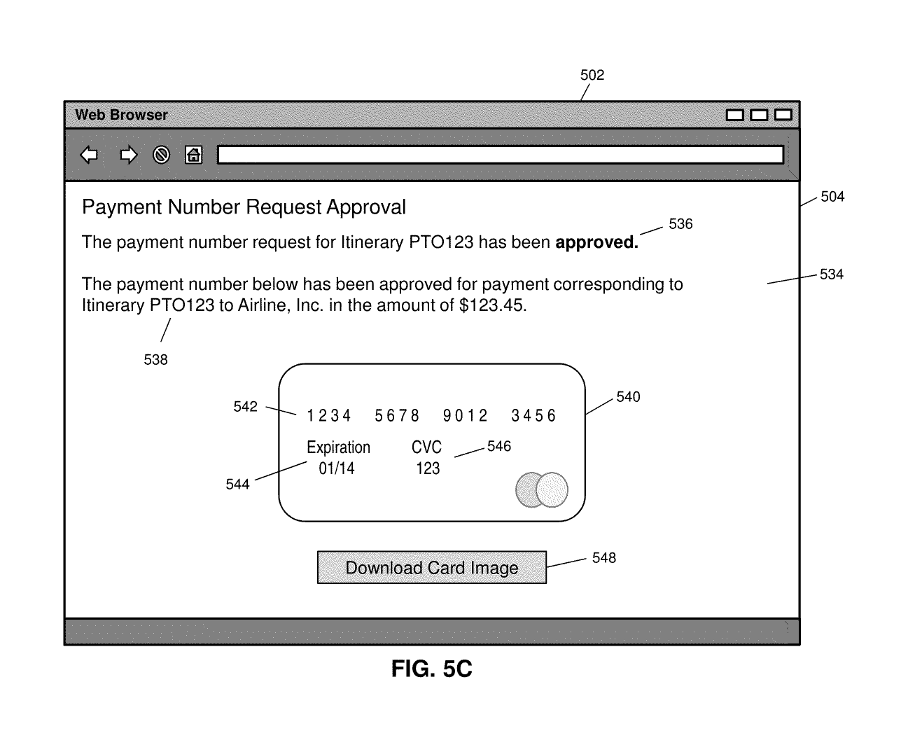

FIGS. 5A-5C illustrate a graphical user interface for the requesting and receipt of a controlled payment number used to provide enhanced control of travel purchases. It will be apparent to persons having skill in the relevant art that the interface illustrated in FIGS. 5A-5C and discussed herein is provided as means of example only, and that additional interfaces and configurations thereof may be suitable for performing the functions as disclosed herein.

FIG. 5A illustrates a web browsing application program 502. The web browsing application program 502 may include a browsing display 504, which may be configured to display a webpage 506. Although the interface illustrate and discussed herein is illustrated as being displayed via a webpage using a web browsing application program, it will be apparent to persons having skill in the relevant art that the interface may be displayed via other suitable means, such as an independent application program, as an application program interface (API) interfacing with the travel management company 104 or other party, etc.

The webpage 506 may include a client selection 508. The client selection 508 may be used to identify the client 102 on whose behalf the travel purchase is to be made. In some instances, the client selection 508 may include a rule identifier or client identifier associated with the client 102 for use in identifying one or more rule data entries 210 to be satisfied in order to receive a controlled payment number. The webpage 506 may also include a travel type selection 510. The travel type selection 510 may be used to indicate what manner of travel purchase is to be made. In some instances, the processing unit 204 may use the travel type selection 510 to determine where to route a subsequent request for purchase data.

The webpage 506 may further include an itinerary selection 512 and load button 514. The itinerary selection 512 may be used by a user to select a predefined itinerary that has been created by the user prior to requesting a controlled payment number. The load button 514, when interacted with by the user, may prompt the server (e.g., a web server hosting the webpage 506) to identify data associated with the itinerary indicated in the itinerary selection 512 to populate a merchant field 516 and a purchase amount field 518.

The merchant field 516 may include a name or other identifier of one or more vendors 112 with whom the travel purchase is to be arranged. The purchase amount field 518 may include the amount of funds required by the client 102 to secure the desired travel purchase. The processing unit 204 may establish a limit or control for a controlled payment number issued subsequent to the request for the purchase amount indicated in the purchase amount field 518.

The webpage 506 may also include a purchase order field 520 and employee identifier field 522. The purchase order field 520 and employee identifier field 522 may be included based on the client selection 508 and may include any additional data that may be required by the client 102 pursuant to one or more employer purchasing or business rules. The webpage 506 may also include a card image selection 524. The card image selection 524 may be used by the user to indicate whether or not an image of a payment card may be required by one or more vendors 112. In some instances, the card image selection 524 may be made automatically based on the vendor or vendors 112 included in the merchant field 516.

The webpage 506 may further include a submit button 526. The submit button 526, when interacted with by the user, may transmit the payment request to the processing server 106, the payment request including data fields corresponding to the information selected in the webpage 506. It will be apparent to persons having skill in the relevant art that additional data fields may be transmitted to the processing server 106, such as based on the itinerary selection 512, client selection 508, etc., such as a payment account number. In some instances, the processing unit 204 may identify additional data based on one or more data fields included in the payment request. For example, the processing unit 204 may identify a payment account number associated with the client 102 based on the client selection 508.

As discussed above, the processing unit 204 may identify one or more rule data entries 210 and determine if the data included in the payment request satisfies data requirements included in the identified one or more rule data entries 210. If the data requirements are not satisfied, then the user may be presented with an error window 528, as illustrated in FIG. 5B.

The error window 528 may include one or more errors 530 displayed to the user, which may indicate data requirements that were not satisfied. In the example illustrated in FIGS. 5A and 5B, the purchase order field 520 may not include any non-numerical characters, and the employee identifier field 522 must require a six digit identifier to be valid. The user may interact with a return button 532 to return to the fields and selections in order to cancel the request or remedy the errors 530.

Once the data included in the payment request satisfies the data requirements, the processing unit 204 may identify a controlled payment number. As illustrated in FIG. 5A, the user may request an image of a payment card be generated for providing to the one or more vendors 112. Once the processing server 106 identifies a controlled payment number and generates the payment card image, the browsing display 504 may display an approval webpage 534.

The approval webpage 534 may include an indicator 536, which may indicate to the user the approval of the payment number request. The approval webpage 534 may also include confirmation information 538, which may confirm one or more details included in the payment request. As illustrated in FIG. 5C, the confirmation information 538 may include the itinerary identifier, purchase amount, and vendor 112. It will be apparent to persons having skill in the relevant art that the confirmation information 538 may include different information in addition, or alternative to, the information illustrated herein.

The approval webpage 534 may also include a generated payment card image 540. The payment card image 540 may be an image of a payment card to be used by the travel management company 104 in funding the payment transaction for the travel purchase. The payment card image 540 may include a controlled payment number 542, an expiration date 544, and a security code 546. Additional data that may be included in the payment card image 540 will be apparent to persons having skill in the relevant art. In some embodiments, the processing server 106 may also generate a second payment card image of the back of a payment card for use by the user.

The approval webpage 534 may also include a download button 548. The download button 548 may be used such that, when interacted with, may download an image file of the payment card image 540 to the user's computer for use in providing to the global distribution system 108 and/or vendor 112. It will be apparent to persons having skill in the relevant art that the approval webpage 534 may include additional options for obtaining the payment card image 540, such as e-mail, short message service (SMS) message, multimedia service (MMS) message, etc.

### Exemplary Method for Providing Enhanced Control of Travel Purchases

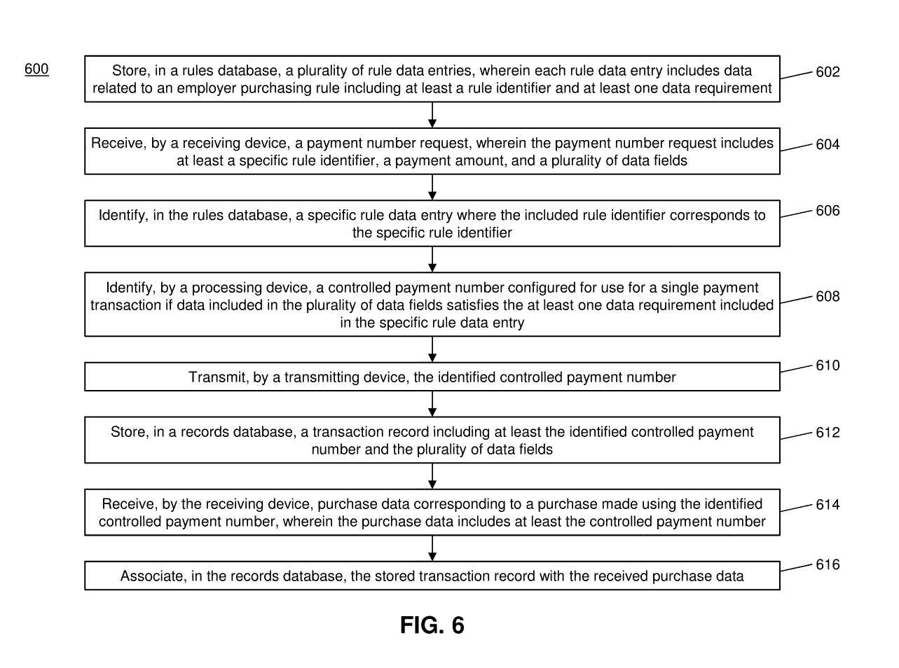

FIG. 6 illustrates a method 600 for the providing of enhanced control of travel purchase using a controlled payment number.

In step 602, a plurality of rule data entries (e.g., rule data entries 210) may be stored in a rules database (e.g., the rules database 208), wherein each rule data entry 210 includes data related to an employer purchasing rule including at least a rule identifier and at least one data requirement. In one embodiment, the rule identifier may be at least one of: a payment account number, a consumer identifier, an account identifier, an entity name, an employer identification number, and a merchant identification number. In some embodiments, the plurality of data fields may include at least one of: purchaser name, purchaser address, purchaser phone number, merchant name, merchant address, merchant phone number, start date, end date, purchase order number, employee identifier, point of departure, destination, method of transportation, itinerary identifier, and account identifier.

In step 604, a payment number request may be received, by a receiving device (e.g., the receiving unit 202), wherein the payment number request includes at least a specific rule identifier, a payment amount, and a plurality of data fields. In step 606, a specific rule data entry 210 may be identified, in the rules database 208, where the included rule identifier corresponds to the specific rule identifier. In step 608, a processing device (e.g., the processing unit 204) may identify a controlled payment number configured for use for a single payment transaction if data included in the plurality of data fields satisfies the at least one data requirement included in the specific rule data entry 210.

In step 610, the identified controlled payment number may be transmitted, by a transmitting device (e.g., the transmitting unit 206). In one embodiment, the identified controlled payment number may be associated with a plurality of transactions controls, wherein the transaction controls correspond to the data included in the plurality of data fields. In step 612, a transaction record (e.g., the transaction record 214) including at least the identified controlled payment number and the plurality of data fields may be stored, in a records database (e.g., the record database 212). In step 614, purchase data may be received, by the receiving device 202, corresponding to a purchase made using the identified controlled payment number, wherein the purchase data includes at least the controlled payment number. In one embodiment, the received purchase data may be included in a Passenger Name Record.

In step 616, the stored transaction record 214 may be associated, in the records database 212, with the received purchase data. In one embodiment, the method 600 may further include: receiving, by the receiving device 202, an authorization request for a payment transaction, wherein the authorization request includes at least the identified controlled payment number and transaction data; and storing, in the transaction record 214, the transaction data included in the received authorization request. In another embodiment, the method 600 may further include transmitting, by the transmitting device 206, the transaction record 214 and the associated purchase data.

In yet another embodiment, the method 600 may further include: transmitting, by the transmitting device 206, a request for additional data if the data included in the plurality of data fields does not satisfy the at least one data requirement included in the specific rule data entry; and receiving, by the receiving device 202, updated data fields that satisfy the at least one data requirement included in the specific rule data entry. In another embodiment, the method 600 may further include: identifying, by the processing device 204, an expiration date and security code associated with the identified controlled payment number; and generating, by the processing device 204, an image of a payment card including the identified expiration date, security code, and controlled payment number, wherein transmitting the identified controlled payment number includes transmitting the generated image of the payment card including the identified controlled payment number.

### Computer System Architecture

FIG. 7 illustrates a computer system 700 in which embodiments of the present disclosure, or portions thereof, may be implemented as computer-readable code. For example, the processing server 106 of FIG. 1 may be implemented in the computer system 700 using hardware, software, firmware, non-transitory computer readable media having instructions stored thereon, or a combination thereof and may be implemented in one or more computer systems or other processing systems. Hardware, software, or any combination thereof may embody modules and components used to implement the methods of FIGS. 3, 4, and 6.

If programmable logic is used, such logic may execute on a commercially available processing platform or a special purpose device. A person having ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device. For instance, at least one processor device and a memory may be used to implement the above described embodiments.

A processor unit or device as discussed herein may be a single processor, a plurality of processors, or combinations thereof. Processor devices may have one or more processor “cores.” The terms “computer program medium,” “non-transitory computer readable medium,” and “computer usable medium” as discussed herein are used to generally refer to tangible media such as a removable storage unit 718, a removable storage unit 722, and a hard disk installed in hard disk drive 712.

Various embodiments of the present disclosure are described in terms of this example computer system 700. After reading this description, it will become apparent to a person skilled in the relevant art how to implement the present disclosure using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

Processor device 704 may be a special purpose or a general purpose processor device. The processor device 704 may be connected to a communications infrastructure 706, such as a bus, message queue, network, multi-core message-passing scheme, etc. The network may be any network suitable for performing the functions as disclosed herein and may include a local area network (LAN), a wide area network (WAN), a wireless network (e.g., WiFi), a mobile communication network, a satellite network, the Internet, fiber optic, coaxial cable, infrared, radio frequency (RF), or any combination thereof. Other suitable network types and configurations will be apparent to persons having skill in the relevant art. The computer system 700 may also include a main memory 708 (e.g., random access memory, read-only memory, etc.), and may also include a secondary memory 710. The secondary memory 710 may include the hard disk drive 712 and a removable storage drive 714, such as a floppy disk drive, a magnetic tape drive, an optical disk drive, a flash memory, etc.

The removable storage drive 714 may read from and/or write to the removable storage unit 718 in a well-known manner. The removable storage unit 718 may include a removable storage media that may be read by and written to by the removable storage drive 714. For example, if the removable storage drive 714 is a floppy disk drive, the removable storage unit 718 may be a floppy disk. In one embodiment, the removable storage unit 718 may be non-transitory computer readable recording media.

In some embodiments, the secondary memory 710 may include alternative means for allowing computer programs or other instructions to be loaded into the computer system 700, for example, the removable storage unit 722 and an interface 720. Examples of such means may include a program cartridge and cartridge interface (e.g., as found in video game systems), a removable memory chip (e.g., EEPROM, PROM, etc.) and associated socket, and other removable storage units 722 and interfaces 720 as will be apparent to persons having skill in the relevant art.

Data stored in the computer system 700 (e.g., in the main memory 708 and/or the secondary memory 710) may be stored on any type of suitable computer readable media, such as optical storage (e.g., a compact disc, digital versatile disc, Blu-ray disc, etc.) or magnetic tape storage (e.g., a hard disk drive). The data may be configured in any type of suitable database configuration, such as a relational database, a structured query language (SQL) database, a distributed database, an object database, etc. Suitable configurations and storage types will be apparent to persons having skill in the relevant art.

The computer system 700 may also include a communications interface 724. The communications interface 724 may be configured to allow software and data to be transferred between the computer system 700 and external devices. Exemplary communications interfaces 724 may include a modem, a network interface (e.g., an Ethernet card), a communications port, a PCMCIA slot and card, etc. Software and data transferred via the communications interface 724 may be in the form of signals, which may be electronic, electromagnetic, optical, or other signals as will be apparent to persons having skill in the relevant art. The signals may travel via a communications path 726, which may be configured to carry the signals and may be implemented using wire, cable, fiber optics, a phone line, a cellular phone link, a radio frequency link, etc.

Computer program medium and computer usable medium may refer to memories, such as the main memory 708 and secondary memory 710, which may be memory semiconductors (e.g. DRAMs, etc.). These computer program products may be means for providing software to the computer system 700. Computer programs (e.g., computer control logic) may be stored in the main memory 708 and/or the secondary memory 710. Computer programs may also be received via the communications interface 724. Such computer programs, when executed, may enable computer system 700 to implement the present methods as discussed herein. In particular, the computer programs, when executed, may enable processor device 704 to implement the methods illustrated by FIGS. 3, 4, and 6, as discussed herein. Accordingly, such computer programs may represent controllers of the computer system 700. Where the present disclosure is implemented using software, the software may be stored in a computer program product and loaded into the computer system 700 using the removable storage drive 714, interface 720, and hard disk drive 712, or communications interface 724.

Techniques consistent with the present disclosure provide, among other features, systems and methods for mapping merchant boundaries. While various exemplary embodiments of the disclosed system and method have been described above it should be understood that they have been presented for purposes of example only, not limitations. It is not exhaustive and does not limit the disclosure to the precise form disclosed. Modifications and variations are possible in light of the above teachings or may be acquired from practicing of the disclosure, without departing from the breadth or scope.

What is claimed is:

1. A method for providing enhanced control of travel purchases, comprising:
storing, in a rules database, a plurality of rule data entries, wherein each rule data entry includes data related to an employer purchasing rule including at least a rule identifier and at least one data requirement;
receiving, by a receiving device, a payment number request, wherein the payment number request includes at least a specific rule identifier, a payment amount, and a plurality of data fields;
identifying, in the rules database, a specific rule data entry where the included rule identifier corresponds to the specific rule identifier;
identifying, by a processing device, a controlled payment number configured for use for a single payment transaction if data included in the plurality of data fields satisfies the at least one data requirement included in the specific rule data entry;
transmitting, by a transmitting device, the identified controlled payment number;
storing, in a records database, a transaction record including at least the identified controlled payment number and the plurality of data fields;
receiving, by the receiving device, purchase data corresponding to a purchase made using the identified controlled payment number, wherein the purchase data includes at least the controlled payment number; and
associating, in the records database, the stored transaction record with the received purchase data.

2. The method of claim 1, wherein the received purchase data is included in a Passenger Name Record.

3. The method of claim 1, wherein the identified controlled payment number is associated with a plurality of transaction controls, the transaction controls corresponding to the data included in the plurality of data fields.

4. The method of claim 1, wherein the rule identifier is at least one of: a payment account number, a consumer identifier, an account identifier, an entity name, an employer identification number, and a merchant identification number.

5. The method of claim 1, wherein the plurality of data fields includes at least one of: purchaser name, purchaser address, purchaser phone number, merchant name, merchant address, merchant phone number, start date, end date, purchase order number, employee identifier, point of departure, destination, method of transportation, itinerary identifier, and account identifier.

6. The method of claim 1, further comprising:
receiving, by the receiving device, an authorization request for a payment transaction, wherein the authorization request includes at least the identified controlled payment number and transaction data; and
storing, in the transaction record, the transaction data included in the received authorization request.

7. The method of claim 1, further comprising:
transmitting, by the transmitting device, the transaction record and the associated purchase data.

8. The method of claim 1, further comprising:
transmitting, by the transmitting device, a request for additional data if the data included in the plurality of data fields does not satisfy the at least one data requirement included in the specific rule data entry; and
receiving, by the receiving device, updated data fields that satisfy the at least one data requirement included in the specific rule data entry.

9. The method of claim 1, further comprising:
identifying, by the processing device, an expiration date and security code associated with the identified controlled payment number; and
generating, by the processing device, an image of a payment card including the identified expiration date, security code, and controlled payment number, wherein transmitting the identified controlled payment number includes transmitting the generated image of the payment card including the identified controlled payment number.

10. A system for providing enhanced control of travel purchases, comprising:
a records database;
a rules database configured to store a plurality of rule data entries, wherein each rule data entry includes data related to an employer purchasing rule including at least a rule identifier and at least one data requirement;
a receiving device configured to receive a payment number request, wherein the payment number request includes at least a specific rule identifier, a payment amount, and a plurality of data fields;
a processing device configured to
identify, in the rules database, a specific rule data entry where the included rule identifier corresponds to the specific rule identifier, and
identify a controlled payment number configured for use for a single payment transaction if data included in the plurality of data fields satisfies the at least one data requirement included in the specific rule data entry; and
a transmitting device configured to transmit the identified controlled payment number, wherein
the processing device is further configured to store, in the records database, a transaction record including at least the identified controlled payment number and the plurality of data fields,
the receiving device is further configured to receive purchase data corresponding to a purchase made using the identified controlled payment number, wherein the purchase data includes at least the controlled payment number, and
the processing device is further configured to associate, in the records database, the stored transaction record with the received purchase data.

11. The system of claim 10, wherein the received purchase data is included in a Passenger Name Record.

12. The system of claim 10, wherein the identified controlled payment number is associated with a plurality of transaction controls, the transaction controls corresponding to the data included in the plurality of data fields.

13. The system of claim 10, wherein the rule identifier is at least one of: a payment account number, a consumer identifier, an account identifier, an entity name, an employer identification number, and a merchant identification number.

14. The system of claim 10, wherein the plurality of data fields includes at least one of: purchaser name, purchaser address, purchaser phone number, merchant name, merchant address, merchant phone number, start date, end date, purchase order number, employee identifier, point of departure, destination, method of transportation, itinerary identifier, and account identifier.

15. The system of claim 10, wherein
the receiving device is further configured to receive an authorization request for a payment transaction, wherein the authorization request includes at least the identified controlled payment number and transaction data, and
the processing device is further configured to store, in the transaction record, the transaction data included in the received authorization request.

16. The system of claim 10, wherein the transmitting device is further configured to transmit the transaction record and the associated purchase data.

17. The system of claim 10, wherein
the transmitting device is further configured to transmit a request for additional data if the data included in the plurality of data fields does not satisfy the at least one data requirement included in the specific rule data entry, and
the receiving device is further configured to receive updated data fields that satisfy the at least one data requirement included in the specific rule data entry.

18. The system of claim 10, wherein
the processing device is further configured to
identify an expiration date and security code associated with the identified controlled payment number, and
generate an image of a payment card including the identified expiration date, security code, and controlled payment number, and
transmitting the identified controlled payment number includes transmitting the generated image of the payment card including the identified controlled payment number.
